(19) United States
(12) Patent Application Publication
(10) Pub. No.: US 2008/0126164 A1
(43) Pub. Date: May 29, 2008

(54) Multi-item single delivery location processing

(75) Inventor: Volker Jaeck, Nussloch (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/594,494

(22) Filed: Nov. 7, 2006

(51) Int. Cl. G06F 17/30

(52) U.S. Cl. 705/8

(57) ABSTRACT

A method for processing an order for quantities of several different items involves identifying locations that handle all of the different items, determining whether one of the locations can supply the requested quantities of all of the different items, and confirming the order if such a location exists. Systems and software to implement related methods are also described.

### FIELD

The invention relates to supply chain management. More specifically, the invention relates to techniques for improving order fulfillment logistics.

### BACKGROUND

Supply chain management (“SCM”) systems are important tools that help businesses manage their workflow, plan future operations, meet obligations and reduce certain costs. An SCM system monitors goods, materials and services related to the process of turning raw materials into finished products and then delivering them to a customer. In some industries, every step of the process is overseen by a single SCM system, while in other industries, several successive supply chains deal with portions of the process (the “finished product” of an earlier supply chain is the “raw material” of a succeeding chain).

One of the goals of supply chain management is to reduce waste of time, materials and activity in the production process. For example, a manufacturer may wish to avoid keeping an excessive stockpile of raw materials or maintaining a large inventory of finished product, but these desires must be balanced against the risk of running out of raw materials or being unable to fulfill a large order. SCM is a complex, multi-faceted problem. For example, the general desire to avoid keeping a stockpile of raw materials may be tempered by the opportunity to obtain one of the materials at a favorable price. Uncertain or unpredictable conditions such as weather or political turmoil can also affect a production process; a good SCM may assist with modeling and planning for such contingencies.

Since supply chain management systems affect the production process, even small improvements in management performance, multiplied by the volume of the production channel, can yield large benefits.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an environment where an embodiment of the invention can be used.

FIG. 2 outlines order fulfillment planning according to an embodiment.

FIG. 3 shows a computer system that can support a supply chain management application implementing an embodiment of the invention.

FIGS. 4A-4D show four rules for a rule-based strategy planner that can be used in conjunction with an embodiment of the invention.

### DETAILED DESCRIPTION

Embodiments of the invention analyze orders for multiple different items and attempt to fulfill the orders with material from a single physical location. Orders may be subject to additional constraints, and these further constraints may also be considered when searching for a single source. If no appropriate single source can be found, strategies to permit single-source fulfillment are designed and ranked, and one of the strategies may be selected for implementation.

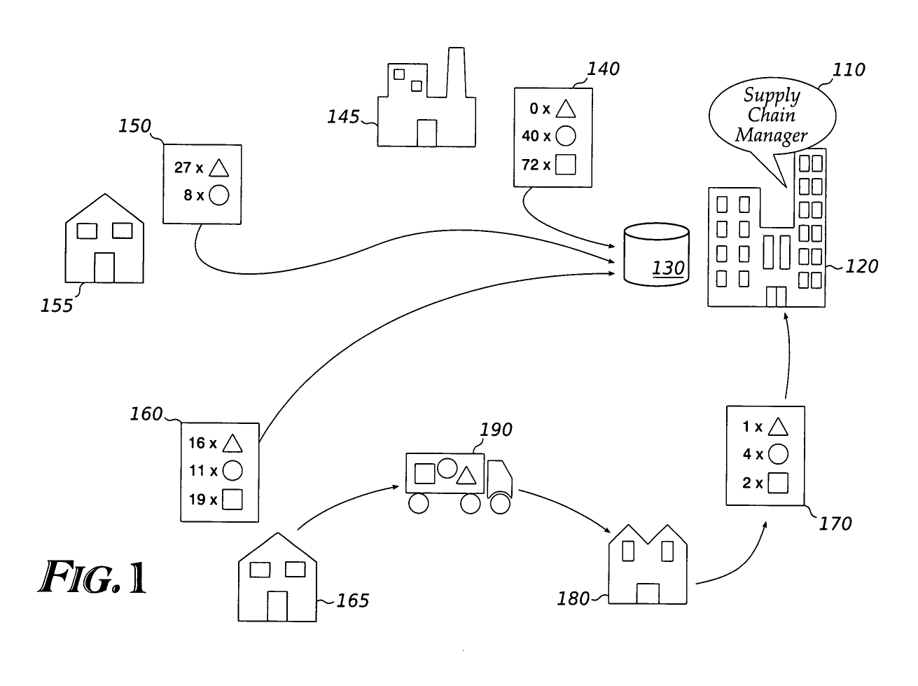

FIG. 1 shows an overview of an environment within which an embodiment of the invention may be used. A supply chain management (“SCM”) system 110, perhaps operated at a corporate headquarters 120, maintains a database 130 of information regarding goods, services, and activities that affect a business entity's operations. For example, SCM 110 may collect and store information about inventories 140, 150 and 160 of various items at facilities 145, 155 and 165. The facilities may be, for example, warehouses or factories operated directly by the business entity, or supply depots of business partners from which the entity obtains some of its materials. SCM 110 may interact with other SCMs (not shown) operated by these business partners.

When an order 170 for a plurality of different items arrives from a customer 180, the SCM system 110 processes the order 170 and other information in database 130 to create a set of locations that handle all of the different items in the order, and then searches the set of locations to find a location that can supply the requested quantities of all of the items in the order. In FIG. 1, for example, facility 155 does not handle one of the items ordered, so it is not included in the set. Facilities 145 and 165 both handle all the items of the order, but facility 145 has no inventory of one of the items. Therefore, in this simple example, SCM 110 will confirm the order to be shipped 190 from facility 165.

FIG. 1 depicts an extremely simple situation where only current inventories 140, 150 and 160 are consulted to find a location from which to fulfill order 170. In a practical system, much more comprehensive information may be available to a supply chain management system. For example, in addition to current inventories, an SCM may have shipping or production information to indicate that, while certain items are not available now, they are expected to be available before a certain date. With this information, the SCM can confirm an order with a required delivery date based on future expectations, not just current information.

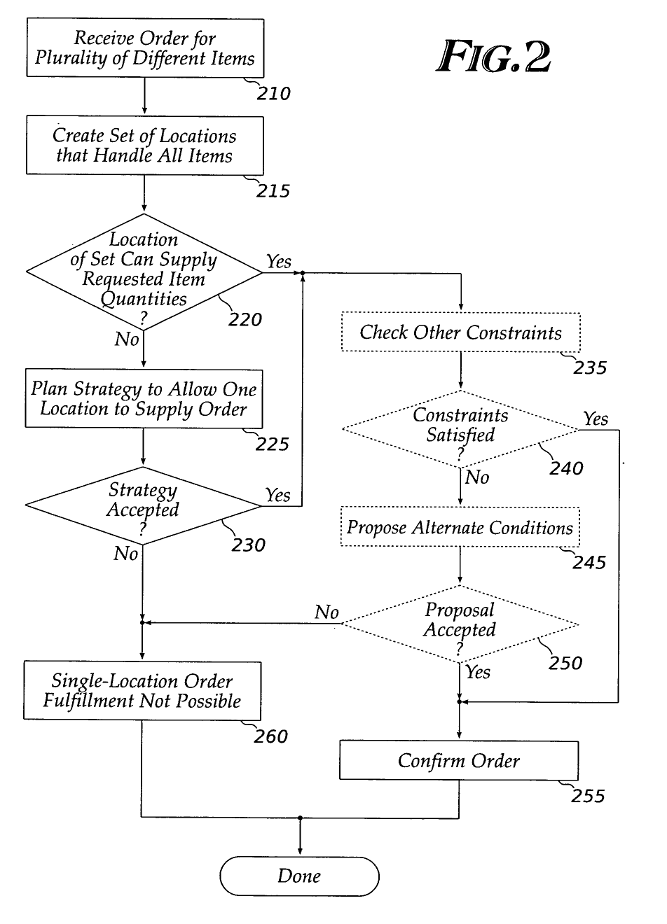

FIG. 2 outlines a process that an SCM system follows according to an embodiment of the invention. The process begins with the receipt of an order for a plurality of different items (210). In other words, the order expresses a customer's desire to obtain one or more units of a first item or service, and also one or more units of a second, different item or service. The SCM creates a set of locations that handle all of the ordered items (215). At this early stage in the process, current and/or future availability of the items need not be considered (although it may be); instead, locations (e.g. warehouses, supply depots and factories) that customarily process, or that are equipped to process, the items, are added to the set.

The locations of the set are examined in turn to determine whether a location can supply the requested quantities of all of the ordered items (220). This determination may take into account future expectations: for example, a location may satisfy this test even if its current inventory of an item is insufficient to fulfill the order, as long as its inventory is forecast to be adequate when the order must be shipped. If such a location is found, an embodiment may check other constraints of the order (235), and if the constraints are satisfied (240), the order is confirmed for fulfillment from the location (255). If the other constraints are not satisfied, an embodiment may propose alternate conditions that would permit the order to be fulfilled from the location (245), and if the proposed alternate conditions are accepted (250), the order is confirmed (255). Other constraints are discussed in greater detail below. Some embodiments may not check such constraints, so operations and tests 235-250 are shown in dashed lines.

If no location of the set can supply the requested quantities of all of the ordered items (220), an embodiment may plan a strategy to enable one location to fulfill the order (225). Tactics that a strategy planner may use are discussed below. If the strategy is accepted (230), an embodiment may proceed to check other constraints, as described above, and confirm the order if the constraints are met (or proposed alternate conditions are accepted).

If no planned strategy is accepted, or no proposed alternate conditions (if any) are accepted, it is not possible to fulfill the order from a single location (260), so alternate methods of fulfilling the order should be pursued.

The operations outlined above with reference to FIG. 2 may be performed in “depth-first” or “breadth-first” fashion, according to the engineering judgment of an implementer of ordinary skill taking into account the other constraints of the system within which the embodiment will operate. In “depth-first” processing, the SCM might identify a first location of the set (215) and then proceed all the way through to either confirm the order from the location (255) or decide that the location cannot serve as the origin for fulfilling the order (260), before identifying and investigating a second location. In “breadth-first” processing, the SCM might identify all the locations of the set at once, and then iterate through each location of the set looking first for a location that can fulfill the order without any further strategic activity, then for locations that could fulfill the order with increasing amounts of planning and activity. Some embodiments may perform some operations depth-first, and others breadth-first, or even change operational styles dynamically in response to situations encountered earlier in a processing sequence.

In general, fulfillment of orders for goods and/or services may be subject to a variety of constraints that are familiar to logistics personnel. For example, large or heavy items may be restricted from certain transport modalities, or may require special delivery permits or other arrangements. For other items, legal restrictions may apply to prevent sales or transfers to customers or other recipients in certain jurisdictions. As mentioned in the discussion of FIG. 2, embodiments of the invention may analyze these constraints and while searching for single locations from which an order can be fulfilled, and if a constraint interferes with a proposed fulfillment, an embodiment may eliminate the source location from consideration, or may propose alternate conditions under which the delivery could be performed. One common constraint that appears in many fulfillment scenarios is the delivery date. An order will often specify a date by which delivery is required, and may specify a date before which delivery is not desired. Processing delivery-date constraints can permit a supply chain management system to answer questions such as “can I get 500 units of X and 200 units of Y by December 15?” Possible answers include “yes,” “no,” and even “no, but the order could be filled by December 20.” Systems that can answer these questions are sometimes called “Available To Promise” or “ATP” systems.

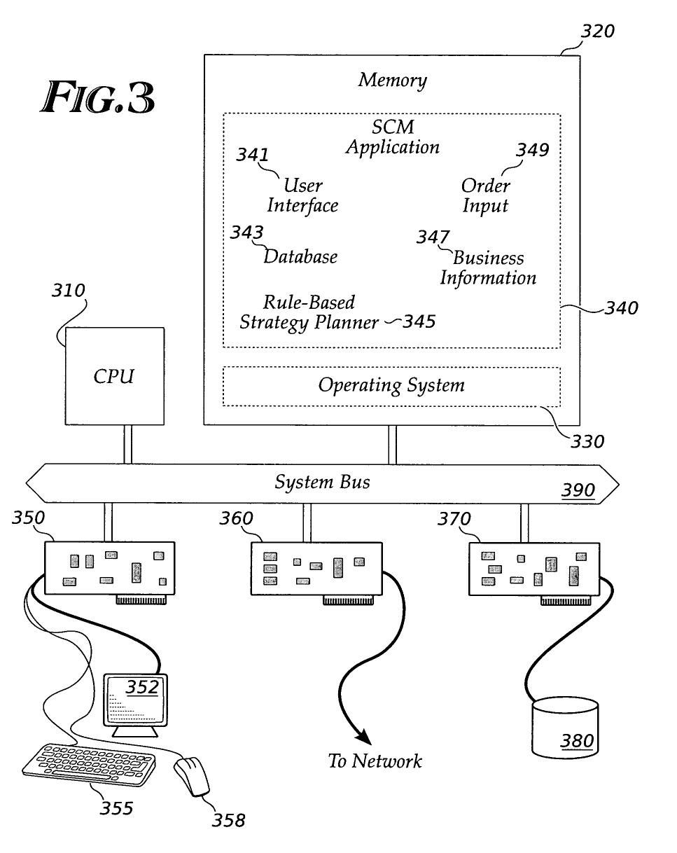

Many supply chain management (“SCM”) systems incorporate a rule-based planning engine to design one or more strategies to achieve business goals. FIG. 3 shows some components and subsystems of a computer system that supports a rule-based SCM system. A programmable processor (“central processing unit” or “CPU”) 310 executes instructions stored in a memory 320. The instructions may include an operating system (“OS”) 330 and a supply chain management application 340. SCM application 340 may include many different functions and subroutines; of relevance to embodiments of the invention are a user interface 341 to present information to a user and to receive commands from the user; a database 343 to store and retrieve information; a rule-based strategy planner 345, described in greater detail below; business information collection logic 347 to retrieve and process the information upon which decisions are based; and an order input section 349 to receive orders from customers.

A system may also include a hardware interface 350 for displaying information on a monitor 352 and/or receiving user input from peripherals such as keyboard 355 and mouse 358. A network interface 360 permits the system to exchange information with other systems over a local area network (“LAN”), a wide-area network (“WAN”) or other type of distributed data network such as the Internet. A mass storage interface 370 permits the system to read and write data, such as inventory and production information, rules for the rule-based system, and so forth, on a non-volatile storage medium such as a hard disk 380. The various parts of the system communicate over one or more channels represented collectively here as system bus 390.

A rule-based strategy planner operates by modeling a “start” situation and searching for a sequence of actions that lead to a desired “finish” situation. The actions may be expressed in terms of “rules” such as, “if a desired quantity of an item is unavailable then order the item from a supplier.” Rule-based systems often operate recursively, breaking a high-level problem down into a sequence of sub-problems and then attacking each sub-problem individually. A rule-based system can help identify strategies to enable an order for multiple different items to be filled from a single location, according to embodiments of the invention.

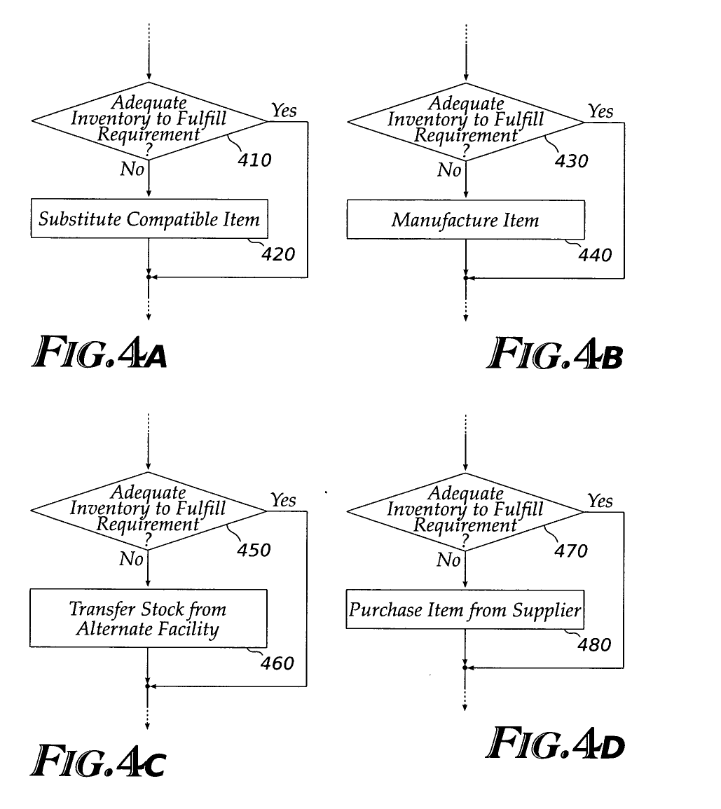

FIGS. 4A-4D illustrate several rules that may be useful in the strategy-planning operation mentioned with reference to FIG. 2, element 225. Each rule can be used when a problem (or sub-problem) states that an inadequate quantity or amount of an ordered item is available at a location. The decision boxes in these flowchart fragments represent the “if” portion of a rule, while the subsequent box specifies a tactic that may be applicable. Thus, in FIG. 4A, if inventory is inadequate (410), then a compatible item or material may be substituted (420). If this rule is applied, the strategy planner might then proceed by attempting to identify compatible items and to determine whether adequate inventory of the compatible item was available.

In FIG. 4B, if inventory is inadequate (430), then additional stock may be manufactured (440). The strategy planner attempts to find a way for manufacturing to occur, perhaps by locating raw materials and scheduling production activities.

In FIG. 4C, if inventory is inadequate (450), then additional stock may be transferred from another facility (460). The strategy planner searches for a facility that has the required item(s) and is able to supply them timely. Note that this strategy attenuates the benefits of fulfilling a multi-item order from a single facility somewhat, since a subsidiary shipment is arranged to bring one or more of the items from a different facility before fulfilling the order. Furthermore, there may be two different fulfillment plans of significantly different practicality. For example, consider an order for a tractor and its user manual. If the tractor is at warehouse A and the manual is at warehouse B, then the order could be fulfilled in a single shipment by shipping the tractor from A to B, or the manual from B to A. However, shipping the tractor may be significantly more expensive than shipping the manual, so the more practical of the two options would be to ship the manual from B to A, then fulfill the order from warehouse A. To evaluate alternate strategies, a rule-based strategy planner may incorporate a strategy evaluator to compare different plans so that the best (e.g. fastest, cheapest, or simplest) plan may be selected. Unfavorable (expensive, slow, complex) plans, by contrast, may be deprecated.

FIG. 4D shows another rule that could be applied by the strategy planner in designing a plan to permit fulfillment of an order from a single location. If inventory is inadequate (470), then additional stock may be purchased from a supplier (480).

The rules described with reference to FIGS. 4A-4D, and other similar rules that will be apparent to those of skill in the art, can be used by a rule-based strategy planner in designing a strategy to fulfill an order for multiple different items from a single location. In many cases, several different strategies may be possible. An embodiment of the invention can present the strategies to a user via the user interface and permit the user to select one (or to reject all) of the strategies with a confirmation control such as a checkbox or a “Select” button.

It is appreciated that an “order,” as described above, may be a request from a customer to obtain goods and/or services from a supplier. However, for the purposes of embodiments of this invention, orders also include any other manifestation of desire to obtain multiple different items or services at a destination. For example, during the strategy planning process of a supply chain management system, an intermediate sub-problem of obtaining multiple different items at an intermediate warehouse or manufacturing facility may arise. An embodiment of the invention can be used to find an efficient solution to this sub-problem by shipping the multiple different items from a single location to the intermediate warehouse or facility.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g, a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that fulfillment of orders for multiple different items from a single location can also be achieved by software and hardware that distribute the functions of embodiments of this invention differently than herein described. Such variations and implementations are understood to be captured according to the following claims.

I claim:

1. A method comprising:
receiving an order for a plurality of different items;
creating a set of locations that handle all the different items;
determining if a location of the set of locations can supply a requested quantity of all the different items of the order; and
confirming the order if such a location exists.

2. The method of claim 1, further comprising:
identifying other constraints of the order;
determining if a location of the set of locations can satisfy all the other constraints; and
confirming the order if such a location exists.

3. The method of claim 1 further comprising:
defining a strategy to permit one of the locations to supply all of the different items of the order;
determining whether the strategy requires a change in constraints;
seeking approval for the change in constraints; and
confirming the order if the change in constraints is accepted.

4. The method of claim 3 wherein the strategy is one of substituting a compatible product for one of the items of the order, shipping one of the items to the one of the locations from a different location, constructing one of the items at the one of the locations or purchasing one of the items.

5. The method of claim 1 wherein determining comprises:
iterating through the set of locations and for each location identifying if a requested quantity of each item can be supplied within a specified time.

6. The method of claim 5 wherein determining further comprises:
discontinuing the iterating operation if a first location that can supply all of the items within the specified time is found.

7. A system comprising:
an input interface to receive an order for a plurality of items;
a strategy planner to design a plan to fulfill the order from a single facility; and
a confirmation control to accept the plan.

8. The system of claim 7, further comprising:
a strategy evaluator to compare two different plans designed by the strategy planner.

9. The system of claim 7 wherein the strategy planner is a recursive strategy planner.

10. The system of claim 7, further comprising:
a storage device to contain a plurality of rules, wherein
the strategy planner is to apply at least one of the plurality of rules to design the plan.

11. The system of claim 10 wherein a rule specifies manufacturing an item of the plurality of items at the single facility.

12. The system of claim 10 wherein a rule specifies substituting a compatible item for an item of the plurality of items.

13. The system of claim 10 wherein a rule specifies shipping an item of the plurality of items to the single facility.

14. The system of claim 13, further comprising:
logic to deprecate impractical shipping plans.

15. A computer-readable medium containing executable instructions to cause a programmable processor to perform operations comprising:
identifying if one of a plurality of supply depots can fulfill an order for a plurality of items at a requested time; and
conforming the order for the plurality of items if a supply depot that can fulfill the order is identified.

16. The computer-readable medium of claim 15 wherein capacity to fulfill the order comprises having a requested quantity of each of the plurality of items at the requested time.

17. The computer-readable medium of claim 15 wherein identifying comprises forecasting a quantity of each of the plurality of items that is expected to be available at the requested time.

18. The computer-readable medium of claim 15, containing additional instructions to cause the programmable processor to perform operations comprising:
identifying at least one of the plurality of supply depots that handle the plurality of items, but cannot provide a requested quantity of one of the plurality of items at the requested time; and
for each of the at least one of the plurality of supply depots, planning a strategy to permit the supply depot to provide the requested quantity of each of the plurality of items at the requested time.

19. The computer-readable medium of claim 18, wherein the strategy comprises one of substituting a compatible item for one of the plurality of items, transferring additional stock of an item to the supply depot, manufacturing additional stock of an item at the supply depot, or purchasing additional stock of an item.

20. The computer-readable medium of claim 15, containing additional instructions to cause the programmable processor to perform operations comprising:
identifying at least one of the plurality of supply depots that handle the plurality of items, but cannot provide a requested quantity of each of the plurality of items at the requested time;
proposing a change to the requested time that will permit the supply depot to fulfill the order; and
confirming the order if the change is accepted.
